(19) United States
(12) Patent Application Publication
(10) Pub. No.: US 2012/0127111 A1
(43) Pub. Date: May 24, 2012

(54) CONTROL METHODS FOR SENSING DEVICES

(75) Inventor: Martin John Edwards, Crawley (GB)

(73) Assignee: CHIMEI INNOLUX CORPORATION, Chu-Nan (TW)

(21) Appl. No.: 12/950,892

(22) Filed: Nov. 19, 2010

(51) Int. Cl. G06F 3/045

(52) U.S. Cl. 345/174

(57) ABSTRACT

A control method for a display device is provided. The sensing device is contacted by at least one object and includes a sensing array formed by a plurality of parallel sensing electrodes. The control method includes the steps of: identifying a contact area of the at least one object in the sensing array; and evaluating a dimension of the at least one object according to the identified contact area. In one embodiment, a width of at least one of the plurality of sensing electrodes is controlled according to the evaluated dimension of the at least one object. In other embodiments, the distance between two sensing electrodes grouped as one measurement electrode set for capacitance differential measurement is determined according to the evaluated dimension of the at least one object.

### BACKGROUND OF THE INVENTION

1. Field of the Invention

The invention relates to a control method, and more particularly to a control method for a sensing device.

2. Description of the Related Art

FIG. 1 shows a conventional capacitive touch sensing device. As shown in FIG. 1, a conventional capacitive touch sensing device 1 comprises a sensing array 10, a capacitance measurement circuit 11, and a touch position calculation circuit 12. The sensing array 10 is formed by a plurality of horizontal sensing electrodes EH1-EHm extending in a horizontal direction and a plurality of vertical sensing electrodes EV1-EVn extending in a vertical direction. When an object contacts the sensing array 10, capacitances associated with the sensing electrodes are measured by the capacitance measurement circuit 11, and the capacitance measurement circuit 11 generates capacitance data signal in response to the measured capacitances. Then, the capacitance data signal is interpreted by a calculation algorithm provided by the touch position calculation circuit 12 to derive the touch coordinates and/or touch position of the object.

When an object contacts the sensing array 10, the change value of the capacitance data signal generated by the capacitance measurement circuit 11 depends on the dimension of the object and the dimensions of the sensing electrodes. Generally, as the widths of the sensing electrodes increase, the level and the change in the level of the capacitance data signal also increase. When the widths of the sensing electrodes are comparable to the dimension of the object, the amount of the change value of the capacitance data signal is largest. Moreover, output noise of the capacitance measurement circuit 11 may be affected by the dimensions of the sensing electrodes. For example, if the widths of the sensing electrodes are greater than the dimension of the object, the level of the capacitance data signal reaches a maximum value. However, at this time, the output signal-to-noise ratio (SNR) of the capacitance measurement circuit 11 is reduced. In other words, wider sensing electrodes result in a higher output noise levels.

Referring to FIG. 1, the capacitances measured by the capacitance measurement circuit 11 may be cross-capacitances formed at cross points of pairs of orthogonal sensing electrodes or self-capacitance formed between a sensing electrode and a ground. The capacitance measurement circuit 11 may employ differential capacitance measurement to measure the capacitances. In the differential capacitance measurement, when an object contacts the sensing array 10, every two parallel sensing electrodes are used to obtain a differential capacitance data signal for determination of the touch coordinates or touch position of the object. For example, two vertical sensing electrodes are used for the differential capacitance measurement to obtain a differential capacitance data signal. However, when the horizontal distance between two vertical sensing electrodes for the differential capacitance measurement does not match the dimension of the object in the horizontal direction, the output noise of the capacitance measurement circuit 11 may be increased, such that the touch coordinates or position of the object may not be accurately determined.

Thus, it is desired to control the characteristics of the sensing electrodes, such as the widths of the sensing electrodes and the distance between two sensing electrodes for the differential capacitance measurement, according to the dimension of the object contacting the sensing array 10.

### BRIEF SUMMARY OF THE INVENTION

One exemplary embodiment of a control method for a display device is provided. The sensing device is contacted by at least one object. The sensing device comprises a sensing array formed by a plurality of parallel sensing electrodes. The control method comprises the step of: identifying a contact area of the at least one object in the sensing array; evaluating a dimension of the at least one object according to the identified contact area; and determining a width of at least one of the plurality of sensing electrodes according to the evaluated dimension of the at least one object.

One exemplary embodiment of a control method for a display device is provided. The display device is contacted by at least one object. The sensing device comprises a sensing array formed by a plurality of parallel sensing electrodes. Every two sensing electrodes among the plurality of sensing electrodes are grouped as one measurement electrode set for capacitance measurement of the sensing device. The distance between the two sensing electrodes of each measurement electrode set is along a first direction. The control method comprises the steps of: identifying a contact area of the at least one object in the sensing array; evaluating a dimension of the at least one object according to the identified contact area; and determining the distance between the two sensing electrodes of each measurement electrode set according to the evaluated dimension of the at least one object.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional capacitive touch sensing device;

FIG. 2 shows a sensing array in a sensing device;

FIG. 3 shows a flow chart of one exemplary embodiment of a control method for a sensing device;

FIG. 4 shows an exemplary embodiment of a sensing device controlled by the sensing method of FIG. 3;

FIG. 5 shows a flow chart of another exemplary embodiment of a control method for a sensing device;

FIG. 6a shows an exemplary embodiment of a sensing device controlled by the sensing method of FIG. 5;

FIG. 6b shows an exemplary embodiment of a measurement electrode set;

FIG. 7 shows an exemplary embodiment of a display device employing the disclosed sensing device controlled by the control method of FIG. 3 and the sensing device controlled by the control method of FIG. 5; and

FIG. 8 shows an exemplary embodiment of an electronic device employing the disclosed display device of FIG. 7.

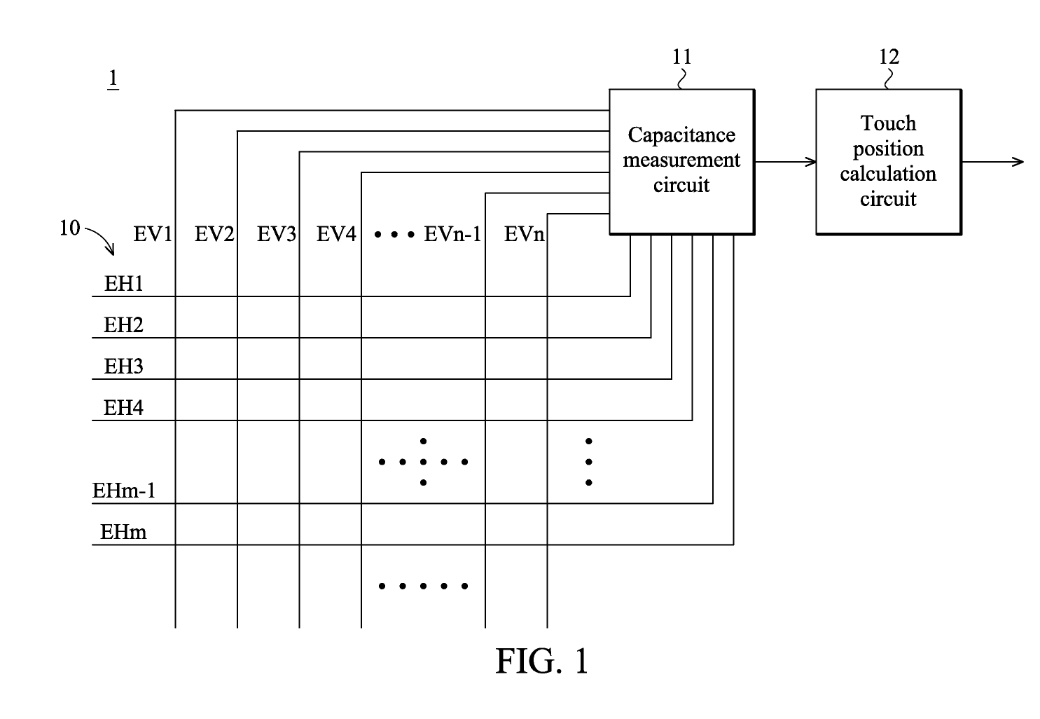

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

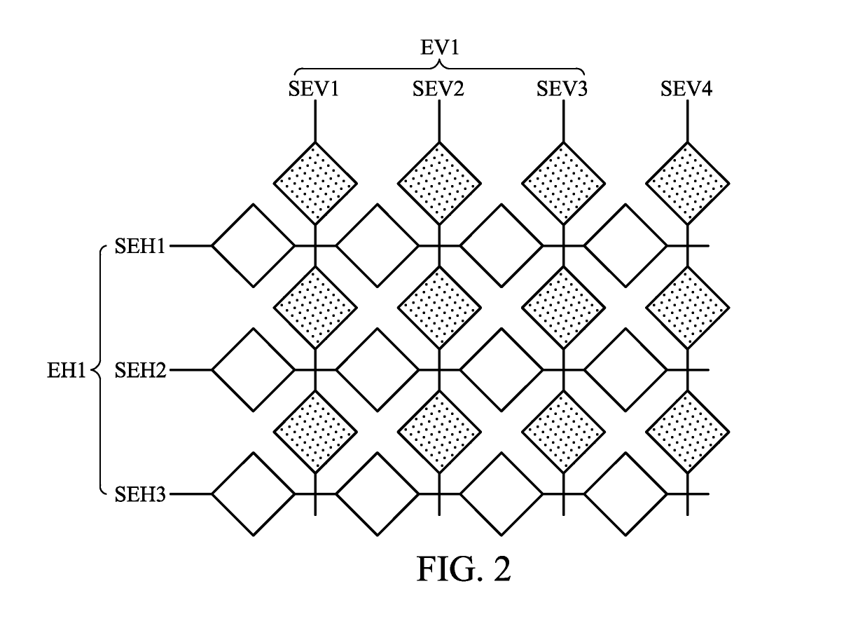

FIG. 2 shows an exemplary embodiment of a sensing array in a display device. As shown in FIG. 2, a sensing array 2 comprises a plurality of horizontal sensing sub-electrodes and a plurality of vertical sensing sub-electrodes. In FIG. 2, three horizontal sensing sub-electrodes SEH1-SEH3 and four vertical sensing sub-electrodes SEV1-SEV4 are given as an example. Between the crossing points of the horizontal sensing sub-electrodes SEH1-SEH3 and vertical sensing sub-electrodes SEV1-SEV4, the sensing sub-electrodes are form diamond shapes for example. A sensing electrode is formed by grouping individual sensing sub-electrodes. For example, a vertical sensing electrode EV1 is formed by grouping three vertical sensing sub-electrodes SEV1-SEV3 and connecting the three vertical sensing sub-electrodes SEV1-SEV3. A horizontal sensing electrode is also formed by grouping several horizontal sensing sub-electrodes and connecting the horizontal sensing sub-electrodes. For example, a horizontal sensing electrode EH1 is formed by grouping three horizontal sensing sub-electrodes SEH1-SEH3 and connecting the three horizontal sensing sub-electrodes SEH1-SEH3.

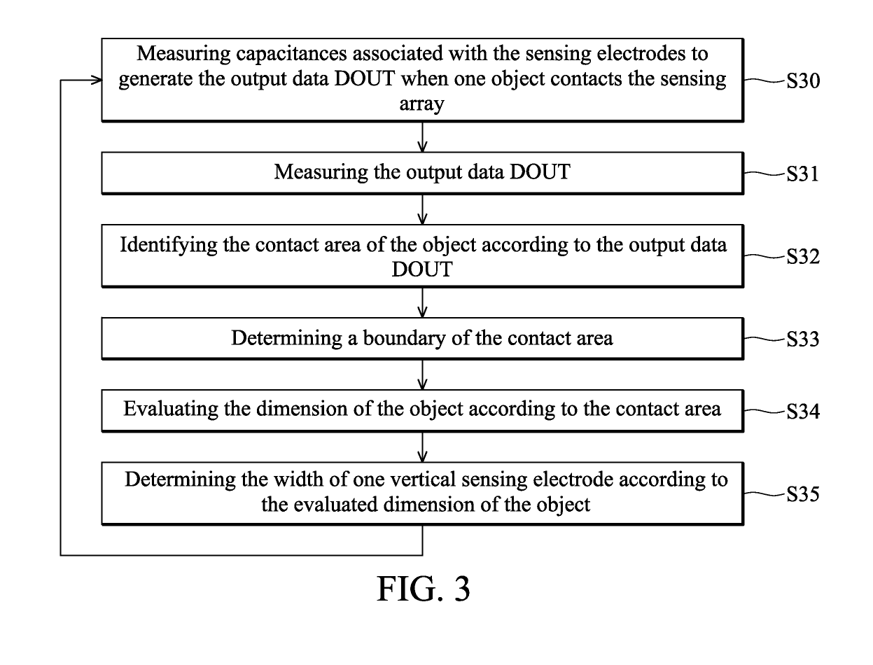

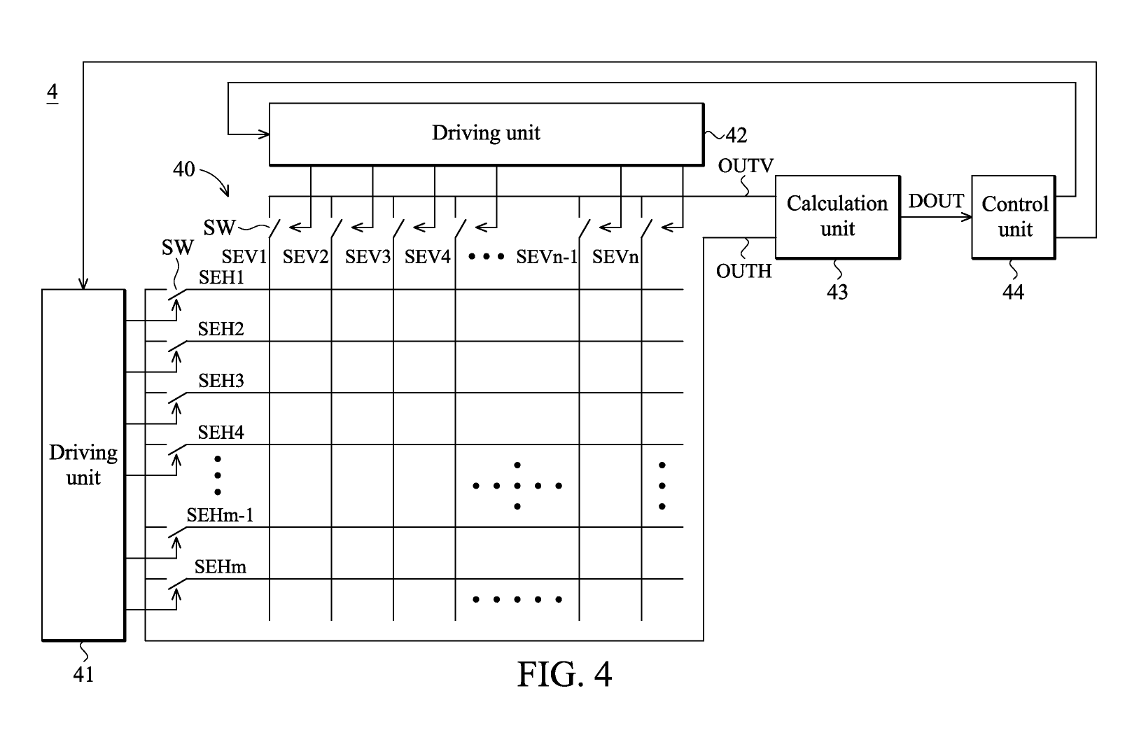

In one exemplary embodiment, a control method for a sensing device is provided to control and adjust a width of at least one sensing electrode in a sensing array of the sensing device. FIG. 3 shows a flow chart of one exemplary embodiment of a control method for a sensing device. FIG. 4 shows an exemplary embodiment of a sensing device controlled by the sensing method of FIG. 3. As shown in FIG. 4, the sensing device 4 comprises a sensing array 40, driving units 41 and 42, a calculation unit 43, and a control unit 44. The sensing array 40 comprises a plurality of horizontal sensing sub-electrodes SEH1-SEHm and a plurality of vertical sensing sub-electrodes SEV1-SEVn. The driving unit 41 is used to control whether each of the horizontal sensing sub-electrodes SEH1-SEHm is connected to a line OUTH through switches SW. The horizontal sensing sub-electrodes simultaneously connected to the line OUTH are grouped to form one horizontal sensing electrode. Thus, the number of the horizontal sensing sub-electrodes simultaneously connected to the line OUTH determines the width of the corresponding horizontal sensing electrode. Similarly, the driving unit 42 is used to control whether each of the vertical sensing sub-electrodes SEV1-SEVn is connected to a line OUTV through the switches SW. The vertical sensing sub-electrodes simultaneously connected to the line OUTV are grouped to form one vertical sensing electrode. Thus, the number of the vertical sensing sub-electrodes simultaneously connected to the line OUTV determines the width of the corresponding vertical sensing electrode. The calculation unit 43 is coupled to the lines OUTH and OUTV. When an object, such as a finger or a stylus, contacts the sensing array 40, the calculation unit 43 measures capacitances associated with the sensing electrodes to derive the touch coordinates and/or touch position of the object and generate corresponding output data DOUT. In the embodiment, the calculation unit 43 may measure cross-capacitances or self-capacitances associated with the sensing electrode to derive the touch coordinates and/or touch position of the object.

In the following, the control method for a sensing device will be described in reference to FIGS. 3 and 4. The width of one vertical sensing electrode to be determined and adjusted is given as an example. However, the same control method can be applied for the horizontal sensing electrodes. In some embodiment, the control method can determine and adjust the width of at least one vertical sensing electrode and the width of at least one horizontal sensing electrode at the same time. When one object, such as a finger or a stylus, contacts the sensing array 40, the calculation unit 43 measures capacitances associated with the sensing electrodes to generate the output data DOUT (step S30). The control unit 44 measures the output data DOUT from the calculation unit 43 (step S31). In the embodiment, the output data DOUT comprises a plurality of data points, and each data point corresponds to a capacitance associated with the sensing electrodes and resulting from when the object contacts the sensing array 40. The control unit 44 then identifies the contact area of the object according to the output data DOUT (step S32) and determines a boundary of the contact area (step S33). The control unit 44 accordingly evaluates the dimension of the object according to the contact area (step S34). In the step S34, the control unit 44 evaluates that the dimension of the object according to the number of the data points in the boundary determined in the step S32. Then, the control unit 44 determines the width of one vertical sensing electrode according to the evaluated dimension of the object (step S35). In other words, the control unit 44 adjusts the width of one vertical sensing electrode according to the evaluated dimension of the object. In the following capacitance measurement, the method returns to the step S30. The calculation unit 43 continuously measures capacitances associated with the sensing electrodes when one vertical sensing electrode has the determined and adjusted width. As described above, the number of the vertical sensing sub-electrodes connected to the line OUTV simultaneously determines the width of the corresponding vertical sensing electrode. Thus, in the step S35, for determining the width of one vertical sensing electrode, the control unit 44 controls the driving unit 42 to change the number of vertical sensing sub-electrodes connected to the line OUTV according to the evaluated dimension of the object.

In the above embodiment, the width of one vertical sensing electrode is determined according to the evaluated dimension of the object. However, in some embodiments, the widths of all of the vertical sensing electrodes can be determined according to the evaluated dimension of the object. In a preferred embodiment, the widths of all of the vertical sensing electrodes may be adjusted to be equal.

In the above embodiment, one object is given as an example, which is in contact with the sensing array 40. In some embodiments, there are a plurality of objects which are in contact with the sensing array 40. When a plurality of objects contact the sensing array 40, the width of one vertical sensing electrode is adjusted according to the smallest one of the evaluated dimensions of the objects, or the widths of all of the vertical sensing electrodes are adjusted to be equal according to the smallest one of the evaluated dimensions of the objects. In some other embodiments, when a plurality of objects contact the sensing array 40, the widths of the sensing electrodes close to one of the objects are determined according to the evaluated dimension of the corresponding object. Preferably, the widths of the sensing electrodes close to one of the plurality of objects are adjusted to be equal.

According to the above embodiments, the width of at least one horizontal/vertical sensing electrode is changed with the dimension of at least one object contacting the sensing array 40. Thus, the output signal-to-noise ratio (SNR) of the calculation unit 43 is increased, so that the touch coordinates of the at least one object can be derived more accurately.

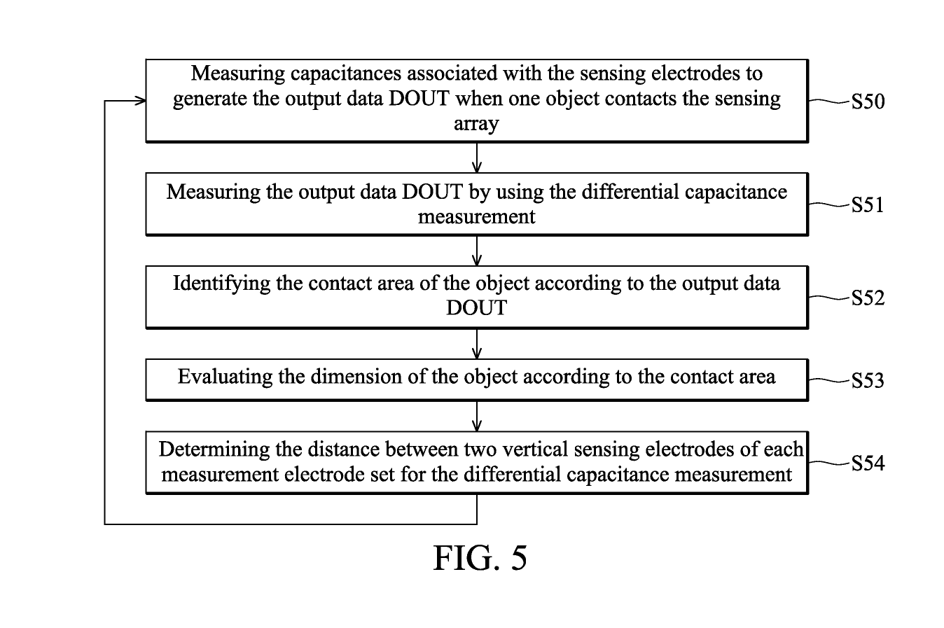

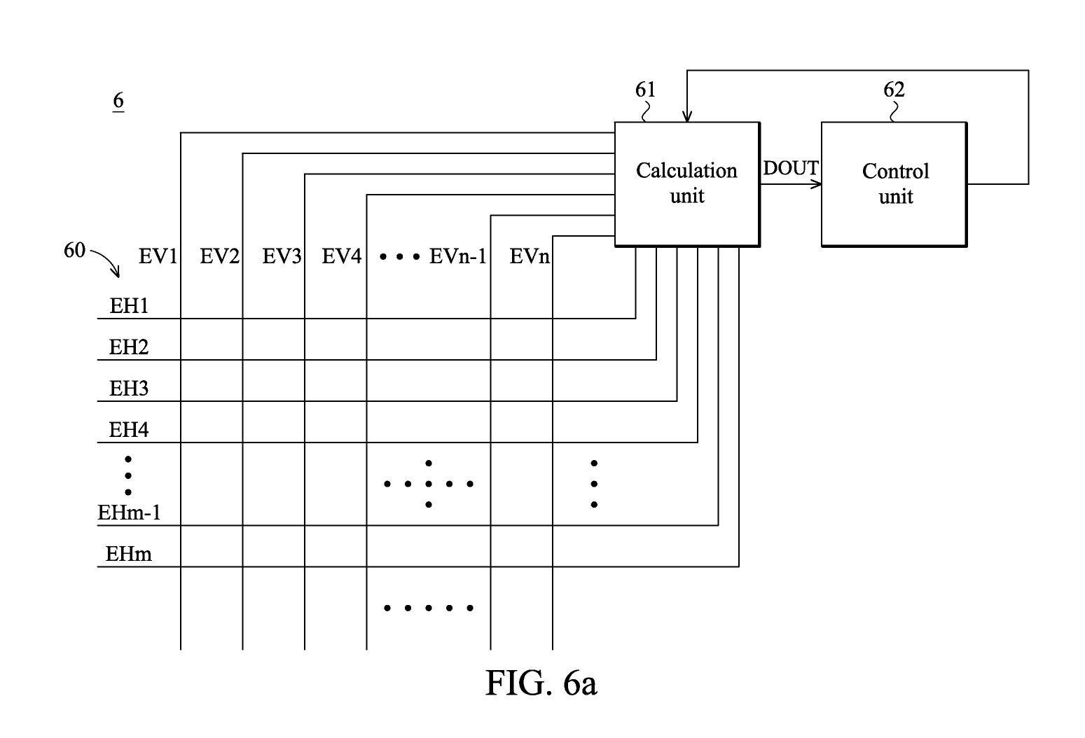

FIG. 5 shows a flow chart of another exemplary embodiment of a control method for a sensing device. FIG. 6a shows an exemplary embodiment of a sensing device controlled by the sensing method of FIG. 5. As shown in FIG. 6a, the sensing device 6 comprises a sensing array 60, a calculation unit 61, and a control unit 62. The sensing array 60 comprises a plurality of horizontal sensing electrodes EH1-EHm and a plurality of vertical sensing electrodes EV1-EVn. The calculation unit 61 is coupled to the horizontal sensing electrodes EH1-EHm and the vertical sensing electrodes EV1-EVn. When an object, such as a finger or a stylus, contacts the sensing array 60, the calculation unit 61 measures capacitances associated with the sensing electrodes to derive the touch coordinates and/or touch position of the object and generate corresponding output data DOUT. In the embodiment, the calculation unit 61 may measure cross-capacitances or self-capacitances associated with the sensing electrodes by differential capacitance measurement to derive the touch coordinates and/or touch position of the object. Thus, for the parallel sensing electrodes (horizontal sensing electrodes or vertical sensing electrodes), every two sensing electrodes among the parallel sensing electrodes are grouped as one measurement electrode set for the differential capacitance measurement, wherein the two sensing electrodes of one measurement electrode set are not adjacent. For example, as shown in FIG. 6b, the vertical sensing electrodes EV1 and EV6 are grouped as one measurement electrode set. The calculation unit 61 comprises a differential amplifier 610 which has two input terminals, wherein one input terminal is connected to one of the measurement electrode set, and the other one input terminal is connected to the other of the measurement electrode set. As shown in FIG. 6b, the distance Dset between the two vertical sensing electrodes of each measurement electrode set is along the horizontal direction. Similarly, when the calculation unit 61 measure self-capacitances associated with the horizontal sensing electrodes by the differential capacitance measurement, every two horizontal sensing electrodes, which are not adjacent, are grouped as one measurement electrode set. The distance between the two horizontal sensing electrodes of each measurement electrode set is along the vertical direction.

In the following, the control method for a sensing device will be described by referring to FIGS. 5 and 6a-6b. The distance of two vertical sensing electrodes of each measurement electrode set is given as an example to be determined and adjusted. However, the same control method can be applied for the horizontal sensing electrodes. In some embodiments, the control method can determine and adjust the distance of two vertical sensing electrodes of one measurement electrode set and the distance of two horizontal sensing electrodes of one measurement electrode set at the same time for the self-capacitance measurement. When one object contacts the sensing array 60, the calculation unit 61 measures capacitances associated with the sensing electrodes to generate the output data DOUT (step S50). The control unit 62 measures the output data DOUT by using the differential capacitance measurement (step S51). The control unit 62 then identifies the contact area of the object according to the output data DOUT (step S52). The control unit 62 accordingly evaluates the dimension of the object according to the contact area (step S53). In the embodiment, the dimension of the object is the maximum height of the object along the horizontal direction. Then, the control unit 62 controls the two input terminals of the differential amplifier 610 of the calculation unit 61 to be coupled to two appropriate vertical sensing electrodes among the vertical sensing electrodes according to the dimension of the object, thereby determining the distance between two vertical sensing electrodes of each measurement electrode set (step S54). In the following capacitance measurement, the method returns to the step S50. The calculation unit 61 continuously measures capacitances associated with the sensing electrodes when the distance between two vertical sensing electrodes of each measurement electrode set has been determined and adjusted. In some embodiments, the distances between the two vertical sensing electrodes of all of the measurement electrode sets are adjusted to be equal.

In the above embodiment, one object is given as an example which contacts the sensing array 60. In some embodiments, there may be a plurality of objects which contacts the sensing array 60. When a plurality of objects contact the sensing array 60, the distance between the two sensing electrodes of each measurement electrode set close to one of the objects is determined according to the evaluated dimension of the corresponding object. Preferably, the distances between the two sensing electrodes of the measurement electrode sets close to one of the plurality of objects are adjusted to be equal.

According to the above embodiments, the distance of the two horizontal/vertical sensing electrodes of each measurement electrode set is changed with the dimension of at least one object which is in contact with the sensing array 60. Thus, the output signal-to-noise ratio (SNR) of the calculation unit 61 is increased, so that the touch coordinates of the at least one object can be derived more accurately.

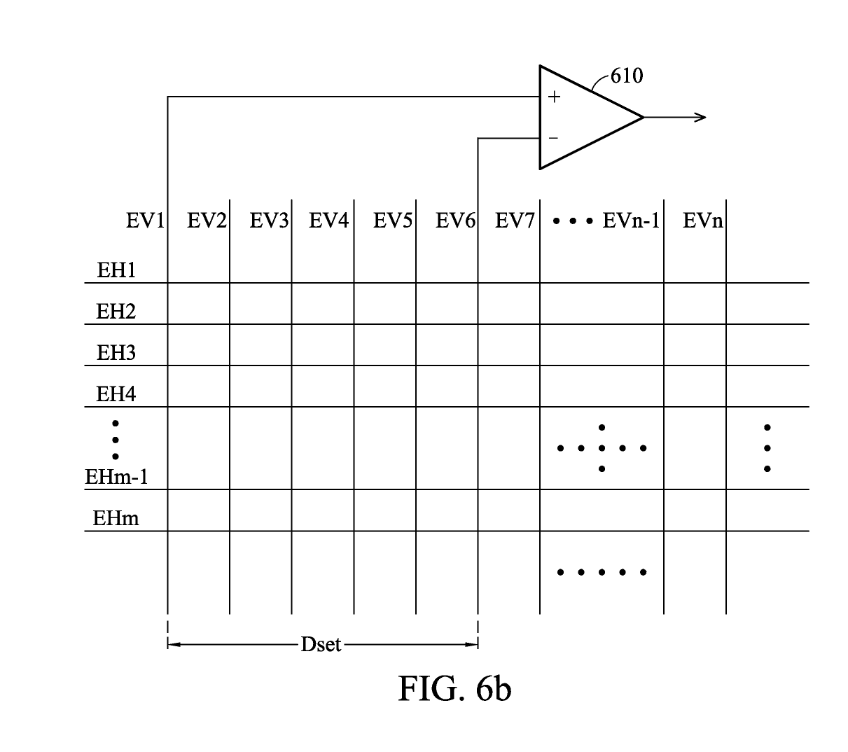

FIG. 7 shows an exemplary embodiment of a display device 7 employing the disclosed sensing device 4 shown in FIG. 4 and controlled by the control method of FIG. 3 or the sensing device 6 shown in FIG. 6a and controlled by the control method of FIG. 5. Generally, the display device 7 includes a controller 70 and the sensing device 4 or 6, etc. The controller 70 is operatively coupled to the sensing device 4 or 6 and provides control signals to the sensing device 4 or 6.

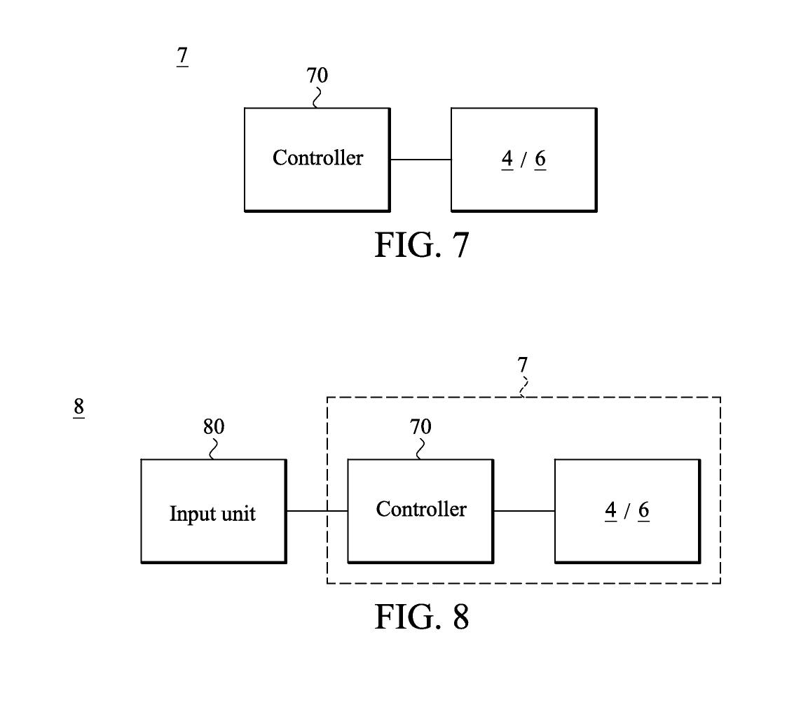

FIG. 8 shows an exemplary embodiment of an electronic device 8 employing the disclosed display device 7. The electronic device 8 may be a PDA, digital camera, notebook computer, tablet computer, cellular phone, a display monitor device, or similar. Generally, the electronic device 8 comprises an input unit 80 and the display device 7 as shown in FIG. 7, etc. Further, the input unit 80 is operatively coupled to the display device 7 and provides input signals to the display device 7. The controller 70 of the display device 7 provides the control signals to the sensing device 4 or 6 according to the input signals.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method for a display device, contacted by at least one object, which comprises a sensing array formed by a plurality of parallel sensing electrodes, comprising:
identifying a contact area of the at least one object in the sensing array;
evaluating a dimension of the at least one object according to the identified contact area; and
determining a width of at least one of the plurality of sensing electrodes according to the evaluated dimension of the at least one object.

2. The control method as claimed in claim 1, wherein in the step of determining the width of at least one of the plurality of sensing electrodes, the widths of all of the plurality of sensing electrodes are adjusted to be equal

3. The control method as claimed in claim 1, wherein when a plurality of objects contact the sensing array, in the step of determining the width of at least one of the plurality of sensing electrodes, the width of the at least one of the plurality of sensing electrodes is adjusted according to the smallest one of the evaluated dimensions of the plurality of objects.

4. The control method as claimed in claim 3, wherein the widths of all of the plurality of sensing electrodes are adjusted to be equal.

5. The control method as claimed in claim 1, wherein when a plurality of objects contact the sensing array, in the step of determining the width of at least one of the plurality of sensing electrodes, the widths of the sensing electrodes close to one of the plurality of objects are adjusted according to the evaluated dimension of the corresponding object.

6. The control method as claimed in claim 5, wherein the widths of the sensing electrodes close to one of the plurality of objects are adjusted to be equal.

7. The control method as claimed in claim 1, wherein the step of identifying the contact area of the at least one object in the sensing array comprises:
measuring output data output, wherein the output data comprises a plurality of data points which correspond to capacitances associated with the plurality of the sensing electrodes and resulting from when the at least one object contacts the sensing array;
identifying the contact area of the at least one object according to the measured output data; and
determining a boundary of the identified contact area.

8. The control method as claimed in claim 7, wherein in the step of evaluating the dimension of the at least one object, the dimension of the at least one object is evaluated according to the number of the data points associated with the sensing electrodes in the determined boundary.

9. The control method as claimed in claim 1, wherein the sensing array comprises a plurality of sub-electrodes, and each of the plurality of sensing electrodes is formed by at least one sub-electrode.

10. The control method as claimed in claim 9, wherein in the step of determining the width of the at least one of the plurality of sensing electrodes, the number of sub-electrodes used to form the at least one of the plurality of sensing electrodes determines the width of the at least one of the plurality of sensing electrodes.

11. A display device comprising:
a sensing device controlled by a control method as claimed in claim 1; and
a controller, wherein the controller is operatively coupled to the sensing panel device.

12. An electronic device comprising:
a display device as claimed in claim 11; and
an input unit, wherein the input unit is operatively coupled to the display device.

13. The electronic device as claimed in claim 12, wherein the electronic device is a PDA, digital camera, notebook computer, tablet computer, cellular phone, a display monitor device.

14. A control method for a display device, contacted by at least one object, which comprises a sensing array formed by a plurality of parallel sensing electrodes, wherein every two sensing electrodes among the plurality of sensing electrodes are grouped as one measurement electrode set for capacitance measurement of the sensing device, and a distance between the two sensing electrodes of each measurement electrode set is along a first direction, comprising:
identifying a contact area of the at least one object in the sensing array;
evaluating a dimension of the at least one object according to the identified contact area; and
determining the distance between the two sensing electrodes of each measurement electrode set according to the evaluated dimension of the at least one object.

15. The control method as claimed in claim 14, wherein in the step of determining the distance between the two sensing electrodes grouped as one measurement electrode set, the distances between the two sensing electrodes of all the measurement electrode sets are adjusted to be equal.

16. The control method as claimed in claim 14, wherein when a plurality of objects contact the sensing array, in the step of determining the distance between the two sensing electrodes of each measurement electrode set, the distance between the two sensing electrodes of each measurement electrode set close to one of the plurality of objects is adjusted according to the evaluated dimension of the corresponding object.

17. The control method as claimed in claim 16, wherein the distances between the two sensing electrodes of the measurement electrode sets close to one of the plurality of objects are adjusted to be equal.

18. The control method as claimed in claim 14, wherein in the step of evaluating the dimension of the at least one object, the dimension of the at least one object is the maximum height of the at least one object along the first direction.

19. The control method as claimed in claim 14, wherein the capacitance measurement of the sensing device is differential capacitance measurement performed by the two sensing electrodes of one measurement electrode set.

20. The control method as claimed in claim 14, wherein the two sensing electrodes of each measurement electrode set are not adjacent.

21. The control method as claimed in claim 14, wherein the step of identifying the contact area of the at least one object in the sensing array comprises:
measuring output data output by using the capacitance measurement of the sensing device, wherein the output data is generated in response to the contact of the at least one object; and
identifying the contact area of the at least one object according to the measured output data.

22. A display device comprising:
a sensing device controlled by a control method as claimed in claim 14; and
a controller, wherein the controller is operatively coupled to the sensing panel device.

23. An electronic device comprising:
a display device as claimed in claim 22; and
an input unit, wherein the input unit is operatively coupled to the display device.

24. The electronic device as claimed in claim 23, wherein the electronic device is a PDA, digital camera, notebook computer, tablet computer, cellular phone, a display monitor device.
